(19) United States
(12) Patent Application Publication
(10) Pub. No.: US 2012/0322029 A1
(43) Pub. Date: Dec. 20, 2012

(54) DENTAL ISOLATOR

(76) Inventor: Valerie Lee Foos, Big Rapids, MI (US)

(21) Appl. No.: 13/162,743

(22) Filed: Jun. 17, 2011

(51) Int. Cl. A61C 5/12

(52) U.S. Cl. 433/138

(57) ABSTRACT

The dental isolator of the present invention is a one-time use dental device which is easy to use as well as easily customizable for the intended patient. The present invention can be used in the preparation and application of a pit and fissure sealant procedure. The dental isolator of the present invention can be adjusted and customized to tailor fit the mouth of the patient. The dental isolator of the present invention is positively retained within the patient's mouth and protects the isolated teeth from moisture on distal, lingual and facial exposure points.

### BACKGROUND OF THE INVENTION

The chewing surface of one's teeth, particularly one's molars and premolars, are highly textured, which makes cleaning these teeth difficult. The chewing surfaces of these teeth have projections and recessions which form the occlusal surface of the molars. Since the occlusal surfaces of the molars and premolars are where the chewing occurs, food particles and plaque can build up in these recessions commonly known in the art as pits and fissures. The pits and fissures are difficult to clean due to their small size, and, if food and plaque are allowed to build up in these areas, tooth decay or caries can develop. Specifically, caries occur largely on the occlusal plane of the tooth. The occlusal plane or surface is generally considered the biting surface of a tooth which actuates against and with an antagonist tooth on an opposing arch. Dental pits and fissures of various shapes are located on this surface where food residue or intraoral bacterial are deposited and can lead to the formation of caries.

In an effort to prevent caries from forming in the pits and fissures of the occlusal surface of a tooth, the tooth can be sealed with a pit and fissure sealant which helps to protect the tooth. In a pit and fissure sealant process, a dental pit and fissure sealant fills the narrow and deep pits and fissures. In this way, the pit and fissure sealant prevents bacteria or food residue from gathering in the difficult to clean pits and fissures so as to prevent the development of caries. Dental pit and fissure sealants of various types are known in the art and are generally comprised of a Bis-GMA resin-based sealant. A dental pit and fissure sealant process generally takes place while the patient has a permanent or mixed dentition in which the permanent dentition is comprised of permanent teeth and the mixed dentition is comprised of both primary teeth and permanent teeth. Generally, this process takes place in patients up to the age of 15 on teeth that do not have cavities. The teeth, particularly the molars, of patients in this age group have pits and fissures which consist of ridges, such as triangular ridges and transverse ridges, which form from the cusp of the molars and premolars to the center part of the tooth's occlusal surface. Oblique ridges and grooves are also found on molars, which create places for food and bacteria to be deposited. A rounded depression, such as a fossa, can be found on the surface of the tooth and is generally formed by the converging of different ridges at a central point in the bottom of a depression where there is a junction of grooves, such as the developmental and supplemental grooves. This conforms to a central pit, which is often the site of tooth decay.

In applying a pit and fissure sealant, a dentist or dental hygienist will generally clean the tooth requiring the sealant with either air abrasive or mildly acidic solution, or both, to score or etch the surface of the tooth such that the surface becomes rough, thereby making it easier for the pit and fusser sealant to adhere properly. Keeping the tooth dry during this procedure is of utmost importance as the pit and fissure sealant might not adhere properly to the tooth surface if saliva and other forms of moisture are on the tooth surface when the sealant is applied.

Thus, a tooth needs to be thoroughly dried and kept isolated from any moisture contamination during a pit and fissure sealant procedure. The liquid sealant material is then placed into the pits and fissures, covering the occlusal surface of the molars. A high intensity curing light (reaction accelerator) is then directed at the occlusal surface to polymerize the sealant material. During the application of the curing light, the tooth must be isolated and dry. The present invention relates to a dental isolator which isolates a tooth or multiple teeth to be sealed and keeps the teeth dry during the application and cure of the pit and fissure sealant.

### SUMMARY OF THE INVENTION

The dental isolator of the present invention is a one-time use dental device which is easy to use as well as easily customizable for the intended patient. The present invention can be used by a dental hygienist in preparation for a pit and fissure sealant procedure. Generally, a Garmer slide or a rubber dental dam is set in place by the dentist when a pit and fissure procedure is needed. The present invention can be adjusted and customized by the trimming of an absorbent member to fit the mouth of the patient appropriately and is easily secured within a patient's mouth as discussed in more detail below.

Another aspect of the present invention is a tooth isolation device particularly adapted for use with upper and lower molars of a dental patient. The tooth isolation device has an absorbent member with a first portion and a second portion disposed on either side of a flexible third portion such that the absorbent member protects the external, internal and distal end of an isolated tooth. The tooth isolation device also includes a retainment member which engages both the first portion and second portion of the absorbent member. The retainment member is configured to be disposed between adjacent teeth of a dental patient.

Another aspect of the present invention is a dental isolator for use in the mouth of a dental patient, where the dental isolator includes an absorbent member having an internal side and an external side and a flexible portion disposed between the internal side and the external side. In this embodiment, the internal side is configured to be disposed on the lingual side of the patient's mouth and the external side is configured to be disposed on the buccal side of the patient's mouth. The dental isolator also includes at least one retainment member which is coupled to the internal side and the external side of the absorbent member in assembly. The retainment member of the dental isolator is configured to fit between adjacent teeth in a dental patient.

Yet another embodiment of the present invention includes a tooth isolation device having a U-shaped absorbent member with a first portion and a second portion forming the legs of the U-shaped absorbent member. The tooth isolation device also includes a retainment member which is coupled to the first portion and the second portion of the absorbent member. The retainment member is configured to fit between adjacent teeth of the user.

These and other features, objects and advantages of the present invention will become apparent upon reading the following description thereof together with reference to the accompanying drawings.

### BRIEF DESCRIPTION OF THE DRAWINGS

FIG. 1 is a perspective view of an absorbent member used in conjunction with the present invention;

FIG. 2 is a top plan view of the absorbent member of FIG. 1;

FIG. 3 is a top plan view of a dental isolator of the present invention;

FIG. 4 is an elevational view of the embodiment shown n FIG. 3;

FIG. 5 is a top plan view of another embodiment of the present invention;;

FIG. 6 is a top plan view of the present invention as installed in the mouth of a patient;

FIG. 6A is a perspective view of the present invention as installed in the mouth of a patient;

FIG. 7 is a top plan view of another embodiment of the present invention as installed the mount of a patient;

FIG. 7A is a top plan view of another embodiment of the present invention shown installed in the mouth of a patient; and

FIG. 8 is a top plan view of yet another embodiment of the present invention, shown installed in the mouth of a patient.

### DETAILED DESCRIPTION OF THE PREFERRED EMBODIMENT

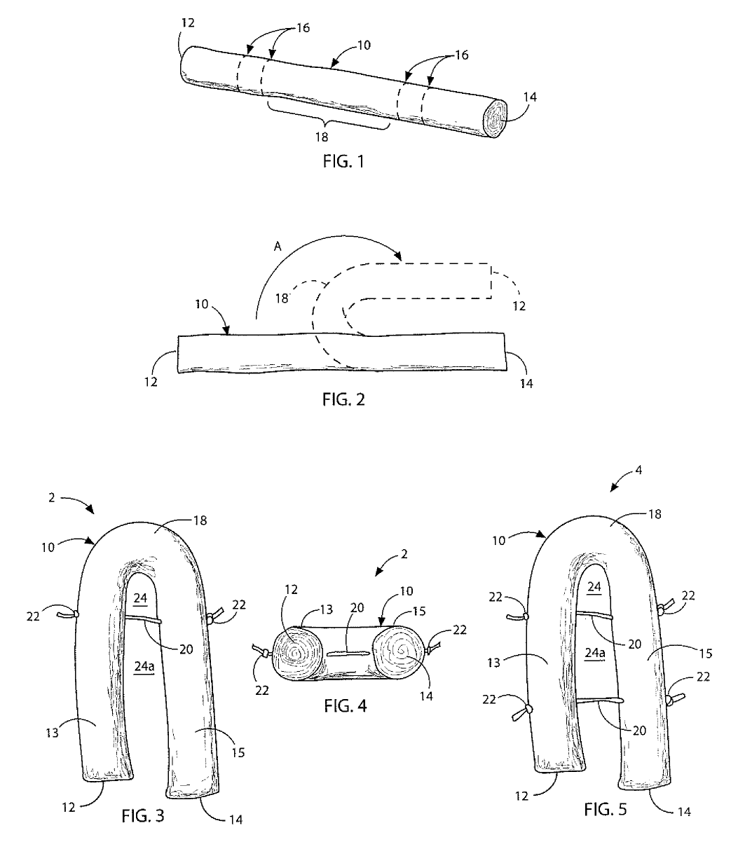

For the purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in following specification, are simply exemplary embodiments. Hence, specific dimensions and other physical characteristics relating to the embodiments disclosed herein are not to be construed as limiting, unless expressly stated otherwise.

Referring to FIG. 1, the reference numeral 10 generally designates an absorbent member as used in the present invention. As shown in FIG. 1, the absorbent member 10 has a first portion with a first end 12 and a second portion with a second end 14 as well as a flexible third portion 18 disposed between the first and second portions. The absorbent member 10 can be trimmed at various locations along the body of the absorbent member 10 between ends 12 and 14. As shown in FIG. 1, the absorbent member 10 can be trimmed at various locations, such as locations 16 indicated by dotted lines on the body portion of absorbent member 10, which will then create new first and second ends 12 and 14. In this way, absorbent member 10 is adjustable in length, providing a custom-tailored absorbent member for use with a patient as further described below.

The absorbent member 10 is made of a material which is capable of absorbing moisture and is ultimately used to keep a tooth isolated and dry during the application of a pit and fissure sealant. The absorbent member 10, as shown in FIG. 1, is in the form of an absorbent cotton roll which is trimmable, flexible, and absorbent for use with the present invention. It is also contemplated that the absorbent member 10 can have different colors as well as different flavoring agents added to the absorbent member material in an effort to make the pit and fissure sealant process more enjoyable for the patient. Different colors of absorbent members 10 can also indicate the general size of the absorbent member being used.

Referring to FIG. 2, the absorbent member 10 is curved along flexible portion 18, such that, as shown in FIG. 2, end 12 is moved toward end 14 along the pathway indicated by arrow A, such that the absorbent member 10 takes on a U-shaped configuration as indicated by the dotted lines in FIG. 2. While portion 18 of the absorbent member 10 is specifically identified as a flexible portion, it is contemplated that the entirety of the absorbent member 10 can be made from a flexible absorbent material such as a cotton roll as described above.

Referring to FIG. 3, the reference numeral 2 generally designates a dental isolator or tooth isolation device of the present invention wherein the absorbent member 10 is bent at flexible portion 18 to create an internal side 13 and an external side 15 corresponding to first and second ends 12, 14, respectively. Disposed between and connecting external side 15 and internal side 13, a dental isolator retainment member 20 is shown. In the embodiment shown in FIG. 3, the dental isolator retainment member 20 is in the form of a polymeric nylon-type floss which has abutment members or coupling members 22 coupled to and located on the outside of internal side 13 and external side 15, which keep the absorbent member 10 in a U-shaped configuration and create a tooth isolation zone 24. The abutment members 22 of the dental isolator retainment member 20 are shown in FIG. 3 as knots tied in the floss or nylon retainment member 20. While the embodiment shown in FIG. 3 uses knots in the floss or nylon retainment member 20, it is contemplated that any abutment-type member would work in this arrangement, so long as the abutment member 22 engages and keeps the absorbent member 10 in the U-shaped configuration, as shown in FIG. 3. Further, it is contemplated that the retainment member 20 can be a one piece elastomeric member having first and second coupling members as further described below.

As shown in FIG. 4, the dental isolator 2 has an absorbent member 10 with first and second ends 12, 14 with the dental isolator retainment member 20 disposed therebetween, wherein the dental isolator retainment member 20 is configured to fit between adjacent teeth of a patient as further described below. It is further contemplated that the dental isolator retainment member 20 can be colored for identification purposes or flavored for the comfort of the patient in which it is installed.

Referring to FIG. 5, the reference numeral 4 generally designates a dental isolator of another embodiment of the present invention having an absorbent member 10 with first and second ends 12, 14 and internal and external sides 13, 15, with a plurality of dental isolator retainment members 20 wherein the dental isolator retainment member 20 nearest flexible portion 18 of the absorbent member 10 defines a tooth isolation zone 24 in conjunction with the bend of the absorbent member 10. A second tooth isolation zone is shown in FIG. 5, as well as FIG. 3, where, in FIG. 5, the second tooth isolation zone is disposed between the dental isolator retainment members 20.

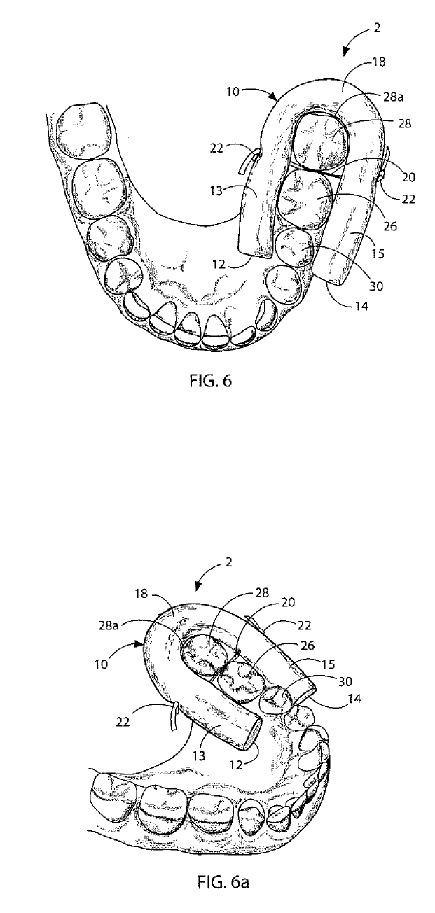

FIG. 6 shows a dental isolator 2, similar to the embodiment shown in FIG. 3, installed in the mouth of a patient with the dental isolator retainment member 20 disposed between first and second molars 26, 28. In this configuration, the dental isolator 2 has placed second molar 28 in the tooth isolation zone 24 (FIG. 3) and the dental isolator 2 is positively captured in the mouth of a patient by the dental isolator retainment member 20 being disposed between first and second molars 26 and 28. As shown in FIG. 6, the absorbent member 10 extends distally around a distal end 28A of second molar 28 and then extends mesially along the facial side of the patient's mouth with external side 15 of absorbent member 10 to protect the teeth from moisture on their facially exposed sides of the teeth. The absorbent member 10 also extends from the distal end 28A of second molar 28 mesially along the lingual side of the patient's mouth by internal side 13 of absorbent member 10. In this way, the dental isolator 2 protects the teeth both facially/externally and lingually/internally, as well as distally with regard to the rearmost tooth, when installed.

As further shown in FIG. 6, the dental isolator retainment member 20 is placed between first and second molars 26, 28 in a method similar to floss being plunged between the first and second molars to the gum line into a space known in the art as the inner proximal space located between adjacent teeth. In this way, once in place, the dental isolator retainment member 20 retains the dental isolator 2 in position, thereby keeping the second molar 28 dry during the application of a ph and fissure sealant. As shown in FIG. 6, the dental isolator 2 wraps the absorbent member 10 around the distal end 28A of the second molar 28, such that the second molar 28 is isolated on all exposed sides by absorbent member 10 to keep saliva and other moisture off the tooth during the application of the pit and fissure sealant. In use, a tooth is isolated using a first dental isolator, it is then dried, etched with a air abrasive or acidic solution and rinsed in preparation for a pit and fissure sealant. The first dental isolator 2 can then be removed and discarded. A second dental isolator 2 can be installed to keep the prepared tooth dry during the application of the pit and fissure sealant. A reaction accelerator, such as a curing light, is then applied to the sealant on the tooth to cure the sealant and solidify the bond between the sealant and the tooth.

FIG. 6A is a perspective view of the same dental isolator configuration shown in FIG. 6. In this configuration, absorbent member 10 is wrapped around the tooth or molar on all exposed sides, such that internal side 13 protects the second molar 28 lingually and external side 15 protects the second molar 28 facially. Flexible portion 18 of absorbent member 10 wraps around the distal end 28A of the second molar 28 to protect the tooth distally from moisture. While the embodiment shown in FIGS. 6 and 6A shows the isolation of the second molar 28, it is also contemplated that the present invention can be used in this configuration to isolate first molar 26. First molar 26 can also be isolated distally if the second molar 28 is not present. It is noted that when second molar 28 is missing, first molar 26 will be in isolation zone 24 when the dental isolator 2 is installed. When the second molar 28 is missing, the dental isolator retainment member 20 will likely be disposed between first molar 26 and primary second molar 30. First molar 26 is also isolated from moisture exposure when second molar 28 is present in that internal side 13 of the absorbent member 10 protects the first molar 26 lingually and external side 15 protects the exposed side of first molar 26 facially in the second isolation zone 24A (FIG. 3).

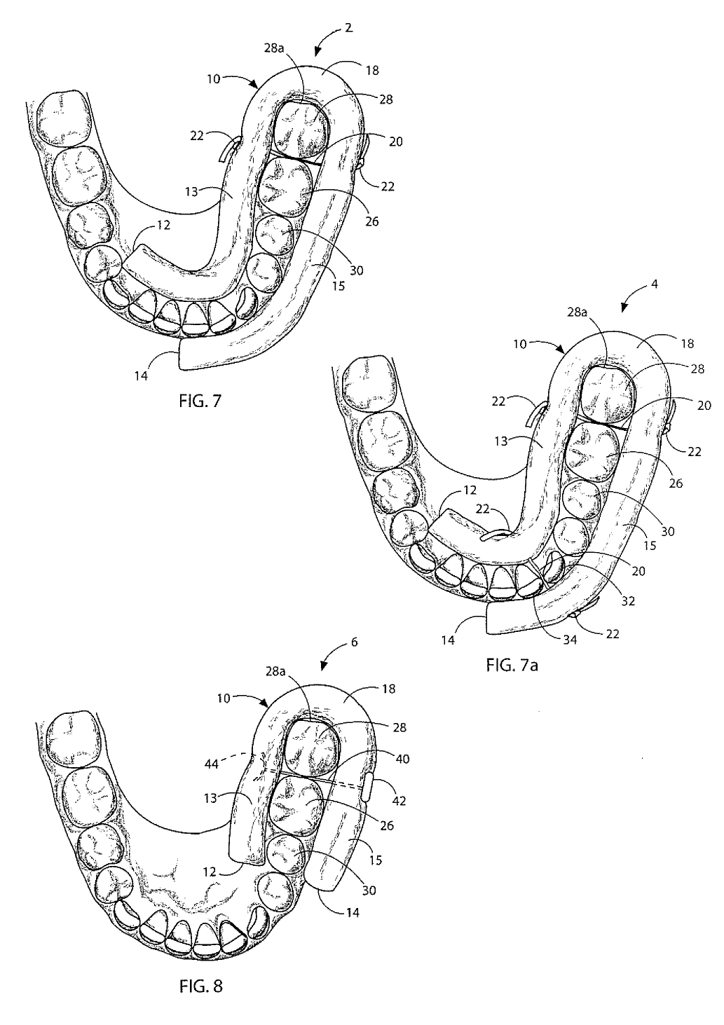

Referring now to FIG. 7, a dental isolator 2 is shown having an absorbent member 10 in which internal side 13 and external side 15 have not been trimmed, such that the internal side 13 projects mesially and lingually along the patient's mouth around to the front of the mouth ending near the patient's canines and incisors. Similarly, in this embodiment, the exterior side 15 of the absorbent member 10 extends around the patients mouth facially and terminates at end 14 which, in this embodiment terminates near the front of the mouth near the patient's incisors. In this configuration, the second molar 28 is isolated in isolation zone 24 and first molar 26 is isolated in isolation zone 24A such that all exposed sides of the teeth are protected from moisture by internal side 13 and external side 15 and flexible portion 18 which wraps around the distal end 28A of second molar 28. In this embodiment, dental isolator retainment member 20 is disposed between first and second molars 26, 28, thereby keeping the dental isolator 2 in place during the various steps of the pit and fissure sealant process.

FIG. 7A shows an embodiment of a dental isolator 4 which is similar to the embodiment shown in FIG. 7. The dental isolator 4 of FIG. 7A further comprises a second dental isolator retainment member 20 disposed between a patient's canine 32 and the patient's lateral incisor 34. The second dental isolator retainment member 20 is positioned similarly to the dental isolator retainment member 20 disposed between first and second molars 28, 26. In this way, the embodiment shown in FIG. 7A retains the dental isolator 4 in place in a patient's mouth using a plurality of dental isolator retainment members 20. The plurality of dental isolator retainment members 20 helps to further ensure that the dental isolator 4 remains in place during the pit and fissure sealant process.

Referring now to FIG. 8, reference numeral 6 generally designates another embodiment of a dental isolator of the present invention. In this embodiment, the dental isolator 6 comprises a dental isolator retainment member 40 having a first coupling member 42 disposed on external side 15 of the absorbent member 10. It is contemplated that the coupling member 42 can be a soft coupling member which does not irritate the cheek of the patient once in place. On the internal side 13 of the absorbent member 10, a second coupling member 44 is shown disposed within the internal side 13 of the absorbent member 10. Together, coupling member 42 and embedded coupling member 44 allow the dental isolator retainment member 40 to keep a U-shaped configuration while also serving to keep the dental isolator 6 retained in place during the sealant process. In this embodiment, the embedded coupling member 44 is fully disposed within the internal side 13 of the absorbent member 10, such that the patient is not exposed internally to any coupling member which can be irritating to the patient. It is further contemplated that another embedded coupling member could be disposed within the external side 15 of the absorbent member 10, such that dual embedded coupling members could be used to retain the dental isolator retainment member 40 in place.

While the embodiments shown in FIGS. 1-8 show a dental isolator retainment member disposed in an inter proximal space between adjacent teeth beyond the contact point of adjacent teeth, it is contemplated that the dental isolator retainment member can also be disposed on the occlusal or biting surface of the tooth in assembly.

The above description is considered to be of the preferred embodiments only. Modifications of the disclosed dental isolator will occur to those skilled in the art and to those who make or use the disclosed dental isolator. Therefore, it is understood that the embodiment shown in the drawings and described above are merely for illustrative purposes and not intended to limit the scope of the invention.

1. A tooth isolation device, particularly adapted for use with upper and lower molars comprising:
a generally U-shaped absorbent member having a first portion and a second portion disposed on either side of a third portion, wherein the first portion is adapted to be disposed on an internal side of a mouth of the dental patient; and
a retainment member adapted to fit between adjacent teeth, wherein the retainment member transversely engages both the first portion and second portion of the absorbent member to define a tooth isolation zone, and further wherein the retainment member comprises at least one embedded coupling member internally disposed within the absorbent member in the first portion of the absorbent member, such that the patient is not exposed to the embedded coupling member in use.

2. The tooth isolation device as defined in claim 1, wherein the absorbent member comprises a cotton roll.

3. The tooth isolation device as defined in claim 2, wherein the absorbent member includes a flavoring agent.

4. The tooth isolation device as defined in claim 1, wherein the retainment member comprises dental floss.

5. The tooth isolation device as defined in claim 4, wherein the dental floss is a flavored dental floss.

6. The tooth isolation device as defined in claim 1, wherein the first portion and second portion of the absorbent member are trimable to make the absorbent member adjustable in length.

7. (canceled)

8. The tooth isolation device as defined in claim 7, wherein the third portion is flexible and configured to wrap around the a distal end of an isolated tooth.

9. (canceled)

10. A dental isolator for use in the mouth of a dental patient, comprising:
an absorbent member having an internal side and an external side relative to the mouth of the dental patient and a flexible portion disposed between the internal side and the external side; and
at least one retainment member wherein the at least one retainment member is a one-piece unitary retainment member configured to fit between adjacent teeth of a dental patient to retain the absorbent member in place and define a tooth isolation zone in conjunction with the absorbent member,
and further wherein the retainment member comprises first and second embedded coupling members fully disposed within the absorbent member at opposite ends of the retainment member thereby coupling the retainment member to the internal side and the external side of the absorbent member.

11. The dental isolator for use in the mouth of a dental patient as defined in claim 10, wherein the absorbent member is a cotton roll having a generally U-shaped configuration.

12. The dental isolator for use in the mouth of a dental patient as defined in claim 11, wherein the external side of the absorbent member is configured to protect the external side of a patient's teeth;
the internal side of the absorbent member configured to protect the internal side of a patient's teeth; and
the flexible portion of the absorbent member configured to wrap around a distal end of an isolated tooth.

13. (canceled)

14. The dental isolator for use in the mouth of a dental patient as defined in claim 13, wherein the retainment member is comprises essentially of dental floss.

15. The dental isolator for use in the mouth of a dental patient as defined in claim 13, wherein the retainment member comprises an elastomeric material.

16. (canceled)

17. The dental isolator for use in the mouth of a dental patient as defined in claim 10, further comprising a second retainment member operably coupled to the internal side and the external side of the absorbent member, wherein the second retainment member is laterally spaced apart from the at least one retainment member and is further configured to fit between adjacent teeth.

18. (canceled)
